(19) United States
(12) Patent Application Publication
(10) Pub. No.: US 2011/0054890 A1
(43) Pub. Date: Mar. 3, 2011

(54) APPARATUS AND METHOD FOR AUDIO MAPPING

(75) Inventors: Aarne Vesa Pekka Ketola, Tampere (FI); Panu Marten Jesper Johansson, Tampere (FI)

(73) Assignee: Nokia Corporation, Espoo (FI)

(21) Appl. No.: 12/546,905

(22) Filed: Aug. 25, 2009

(51) Int. Cl. G10L 15/00

(52) U.S. Cl. 704/231; 704/E15.001

(57) ABSTRACT

A mobile phone, and corresponding method, which is arranged to detect sounds of different types and to indicate to a user the direction from which those sounds are coming from. The mobile phone includes a microphone for recording sound and a display for providing feedback to the user. The phone also includes a sound mapping program which is arranged to interpret the sound recorded by the microphone and to provide an audio map of detected sounds. This is presented to the user on the display.

### TECHNICAL FIELD

This invention relates to an apparatus and a method for audio mapping.

### BACKGROUND TO THE INVENTION

Computing devices such as mobile devices include microphones which are typically used for a user to make a voice call. The microphone can also be used to record memos and provide voice commands to the mobile device. Mobile devices also include various mechanisms for detecting movement of the mobile device. For example, mobile devices include motion sensors in the form of accelerometers and digital compasses.

Increasingly, mobile device manufacturers are required to provide functions which assist disabled people. For example, mobile devices may include easy to read displays for those with poor sight. Alternatively, mobile devices may provide audio instructions of how to perform certain functions, again for those with poor sight. Mobile devices include, but are not limited to, mobile telephones, PDAs and laptop computers.

### SUMMARY OF EXAMPLES OF THE INVENTION

An example of the invention provides an apparatus comprising: at least one processor and at least one memory including computer program code, the at least one memory and the computer program code configured to, with the at least one processor, cause the apparatus at least to: identify at least one audio type based on a signal representative of sound; determine the direction of any of said identified audio types; and provide feed-back to a user of the identified audio types and the direction of said audio types.

The apparatus may further comprise at least one audio input, wherein said signal representative of sound is received via said at least one audio input. The at least one audio input port may be at least one microphone. The apparatus may further comprise a display, and said feed-back is displayed on said display. The apparatus may further comprise a motion sensor, and said processor uses an output from said motion sensor to determine the direction of the at least one audio type. The apparatus may further comprise a digital compass, and said processor uses an output from said digital compass to determine the direction of the at least one audio type. The apparatus may have a plurality of audio profiles stored thereon, and said processor identifies audio types based on said audio profiles. The audio input port may be suitable for a microphone to be coupled to.

In a further example, the apparatus may include a location determination module, arranged to determine the apparatus location, wherein the location of a detected sound may be estimated, based on said apparatus location and the detected direction. The location determination module may be a GPS unit.

In a further example, the invention provides a personal mobile communication device comprising the apparatus described above.

In a further example, the invention provides a method comprising: identifying at least one audio type based on a signal representative of sound received via at least one audio input; determining the direction of any of said identified audio types; and providing feed-back to a user of the identified audio types and the direction of said audio types.

Providing feed-back may include providing feed-back via a display. Determining direction may be done using a motion sensor. Determining direction may be done using a digital compass. Identifying at least one audio type may be done using a plurality of audio profiles. The method may further comprise navigating a user to an audio type selected by a user. Identifying at least one audio type may include identifying a single audio type selected by a user. Identifying at least one audio type may include identifying all audio types present in said signal representative of sound.

A further example of the invention provides a computer program or a suite of computer programs arranged such that when executed by a computer they cause the computer to operate in accordance with the method described above.

A further example of the invention provides a computer readable medium storing the computer program, or at least one of the suites of computer programs.

A further example of the invention provides an operating system for causing a computing device to operate in accordance with a method described above.

A further example of the invention provides a device substantially as described herein and as shown in FIGS. 1 to 6.

A further example of the invention provides an apparatus comprising: means for identifying at least one audio type based on signals representative of sound received via said at least one audio input; means for determining the direction any of said identified audio types; and means to provide feed-back to a user of the identified audio types and the direction of said audio types.

This summary provides examples of the invention which are not intended to be limiting on the scope of the invention. The features of the invention described above and recited in the claims may be combined in any suitable manner. The combinations described above and recited in the claims are not intended to limit the scope of the invention.

Features and advantages associated with the examples of the invention will be apparent from the following description of some examples of the invention.

### BRIEF DESCRIPTION OF THE DRAWINGS

Examples of the invention are hereinafter described with reference to the accompanying diagrams where:

FIG. 1 shows a mobile telephone in accordance with an example of the invention;

FIG. 2 shows certain software components stored on the mobile telephone shown in FIG. 1;

FIG. 3 shows a method of operation of the mobile phone shown in FIG. 1 in accordance with an example of the invention;

FIG. 4 shows a menu displayed on the mobile telephone shown in FIG. 1;

FIG. 5 shows an audio map displayed on the mobile telephone in FIG. 1; and

FIG. 6 shows a further method of operation of the mobile phone shown in FIG. 1 in accordance with an example of the invention.

### DESCRIPTION OF EXAMPLES OF THE INVENTION

An example of the invention is a mobile phone which is arranged to detect sounds of different types and to indicate to a user the direction from which those sounds are coming from. The mobile phone includes a microphone for recording sound and a display for providing feedback to the user. The phone also includes a sound mapping program which is arranged to interpret the sound recorded by the microphone and to provide an audio map of detected sounds. This is presented to the user on the display.

Such a mobile phone is useful for enabling a user to determine sound sources. There may be a number of reasons for this. For example, individuals who are hard of hearing would benefit from being able to determine the direction of a sound. Partially deaf people, or those who only have hearing in one ear may also benefit from sound direction information. The phone could be used to determine the direction of a certain sound when the user is lost in a crowd. If a user is lost in a wood, the phone could help them navigate back to a road, based on road noise. The phone would also be helpful in the dark. Conversely, the phone could be used to find a quiet area, when there are many noise sources.

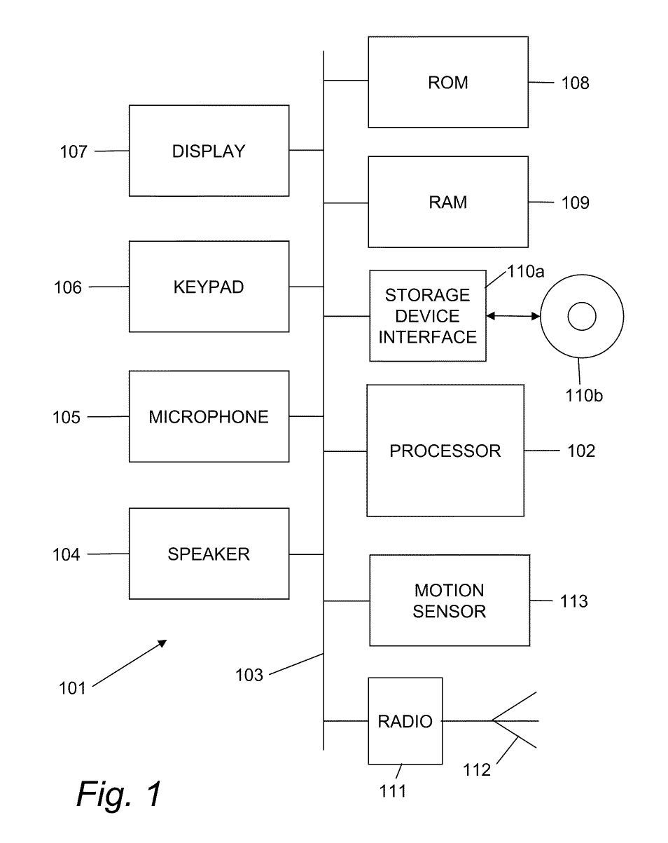

A first example of the invention is described in the context of a mobile telephone. FIG. 1 is a schematic diagram showing some of the components of a mobile telephone (MT) 101. The components of the MT 101 include a processor 102, which is arrange to carry out instructions stored as computer programs on the telephone. The MT 101 also includes a system bus 103 which connects the processor 102 to other components of the device. The bus 103 allows the components to communicate with each other. Here, the components are shown to communicate via a single system bus 103, however, in practice, the MT 101 may include several buses to connect the various components.

The MT 101 also includes an speaker 104, a microphone 105, a keypad 106 and a display 107. These components may also include respective device processors. The mobile telephone 101 also has memory components including a ROM 108, a RAM 109 and a storage device interface 110a. The storage device interface 110a may be an interface for an internal hard drive or a removable storage device such as a compact disc 110b. The ROM 108 has an operating system stored thereon. The operating system is for controlling the operation of the device. The RAM 109 is used while the device is switched on to store temporary data. The telephone 101 also includes a radio 111 and an antenna 112. The radio 111 and antenna 112 allow the telephone to communicate with a mobile phone network in a manner familiar to the person skilled in the art. The MT 101 also includes a motion sensor 113. The motion sensor 113 may be an accelerometer.

This description of the components of MT 101 is one example of the manner in which the components may be arranged. Many variations are possible including different components and different arrangements of those components. The invention is not limited to any particular set of components nor to any particular combination of those components. Advances in computing device technology may result in certain components being replaced by others which perform the same function. Such a device could also embody the invention. In particular, the radio 111 and antenna 112 are optional features. The MT 101 may be a PDA or laptop which do not require a radio. Additionally, the MT 101 may have a WLAN unit rather than a mobile communications radio.

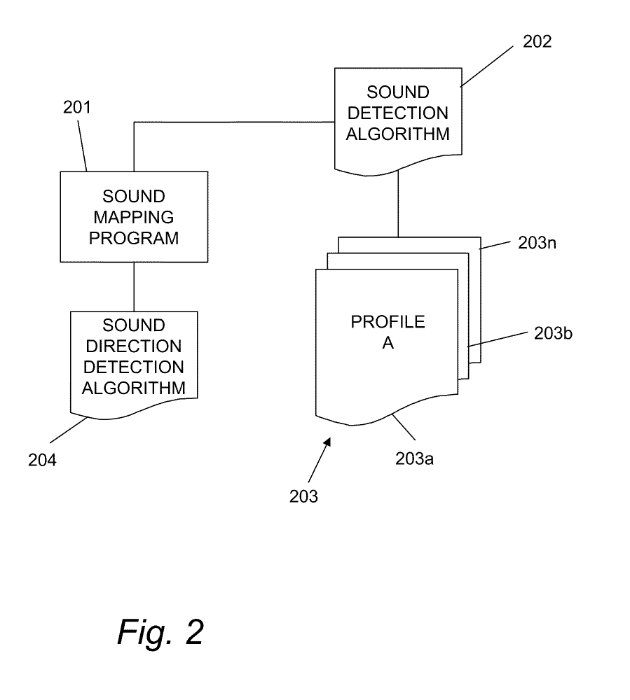

FIG. 2 shows some of the software components of the MT 101 in accordance with the first example. The MT 101 includes a sound mapping program 201 which may be stored on compact disc 110b. The sound mapping program 201 includes code which is arranged to be run by the processor 102. The sound mapping program 201 is arranged to record sound received from the microphone and to detect certain sounds from the recording. The program 201 is also arranged to determine the direction of the detected sounds, relative to the mobile telephone, and to feed this information back to a user. This may be done by using the display to provide visual feedback to the user. The sound mapping program 201 may be stored on any suitable medium. For example, the program may be stored on a compact disc, a flash memory card, or on an internal hard drive.

The sound mapping program 201 includes a sound detection algorithm 202. The sound mapping program 201 uses this algorithm to determine whether or not a recorded audio sample includes any known sounds. The sound mapping program 201 includes an associated audio profile store 203 which includes audio profiles 203a, 203b . . . 203n etc for a number of different sounds. In use, the sound detection algorithm compares the recorded audio with the stored profiles to determine whether the audio sample includes any identifiable sounds.

The MT 101 also includes a sound direction detection algorithm 204 which is used by the sound mapping program 201 to determine the direction from which a sound has originated. In this example, in order to determine the direction from which a sound is originating, the user must turn the MT 101 360° in the horizontal plane. The sound mapping program 201 records sound levels as the user turns the device. The recorded sound levels will include a maximum when the microphone is pointing at the sound source. The sound direction detection algorithm 204 is therefore able to calculate where the sound is originating from, relative to the MT 101. This information is fed back to the sound mapping program 201 so that it can be fed back to the user. The accuracy of the calculations in this example can be improved using two microphones rather than one.

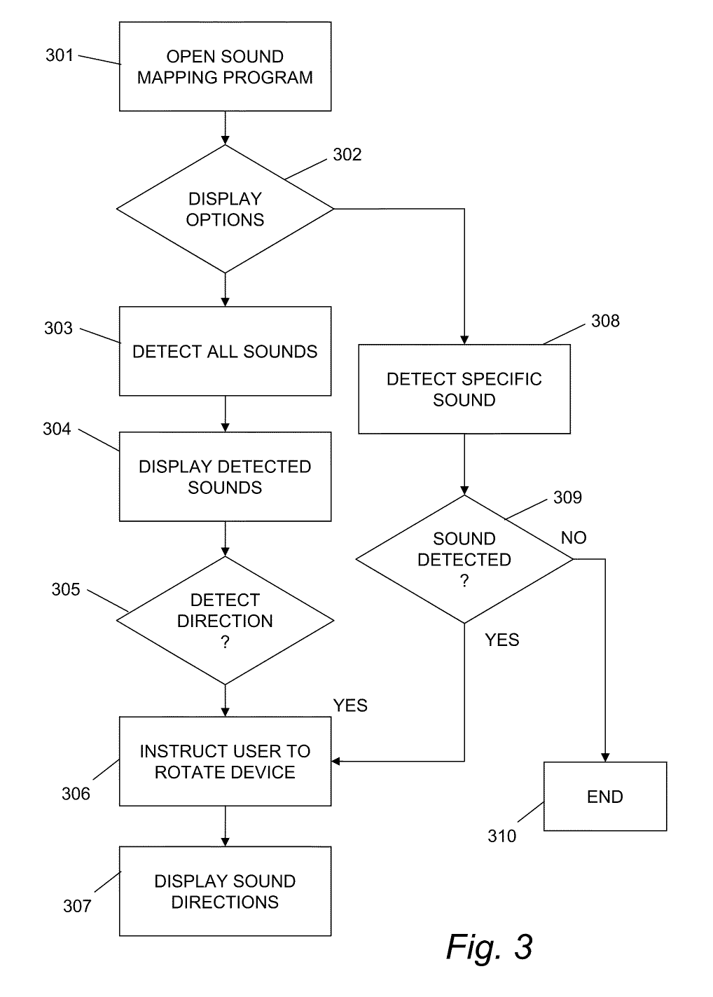

Operation of the MT 101 in accordance with the first example will now be described with reference to FIG. 3. In order to begin recording audio and determining sound types and directions, the user opens the sound mapping program 201 (block 301). The sound mapping program 201 displays various options on the display 107 (block 302). In this example, the options include, “detect all sounds” and “detect specific sound”. If the user selects “detect all sounds”, the sound mapping program 201 performs a sweep of all stored audio profiles 203a, 203b etc, against a recorded audio sample to determine which of the sounds for which profiles exist are present in the recorded audio sample (block 303). The sound mapping program 201 records a sound sample for 5 seconds. This is preferably done while the user is stationary. The sound detection algorithm 202 determines, based on the sample, whether or not any sounds match the audio profiles 203a, 203b etc. Once the sound detection algorithm 202 has detected any sounds, it passes this information to the sound mapping program 201 which displays the detected sounds as a list on the display 107 (block 304). Once the sound mapping program 201 has displayed the detected sounds, the user is given the option to either detect the direction of one of those sounds, or detect the direction of all of the sounds (block 305). In either event, the sound mapping program next instructs the user to slowly rotate the MT 101 (block 306). As the user rotates the MT 101, the sound mapping program records the detected sound. The sound direction detection algorithm 204 then determines the maximum sound levels for each previously detected sound. It passes this information to the sound mapping program 201 so that it can display the direction of each sound (block 307).

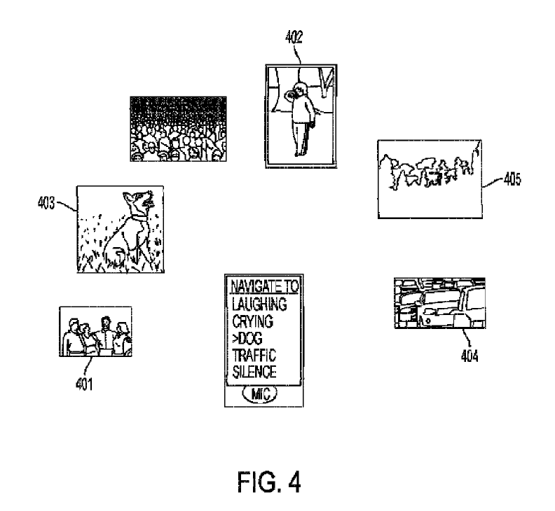

At block 302, the user may also select “detect specific sounds”. In this case, the MT 101 displays a list of the audio profiles stored in the MT 101 (block 308). An example of this is shown in FIG. 4. Here, the user may select, laughing 401, crying 402, dog 403, traffic 404, silence 405 etc. The sound mapping program records a sound sample for 5 seconds. The sound detection algorithm 202 determines, based on the sample, whether or the selected sound is present in the audio sample. The sound mapping program 201 informs the user if the sound has been detected (block 309). If no sound matching a chosen profile is detected, the process ends (block 310). If the matching sound is detected, the process continues to block 306 and the sound mapping program instructs the user to rotate the MT 101 so that direction can be determined.

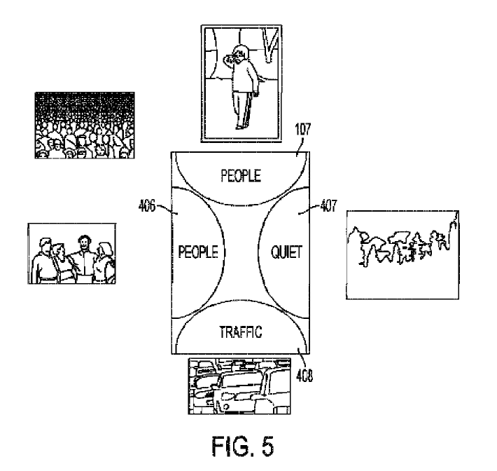

When the sound mapping program 201 has information regarding the detection of sounds and the direction of those sounds, it can display an audio landscape to a user. An example of this is shown in FIG. 5. The display 107 shows a representation of the detected sounds. In this case, this includes people 406, a quiet area 407 and traffic 408.

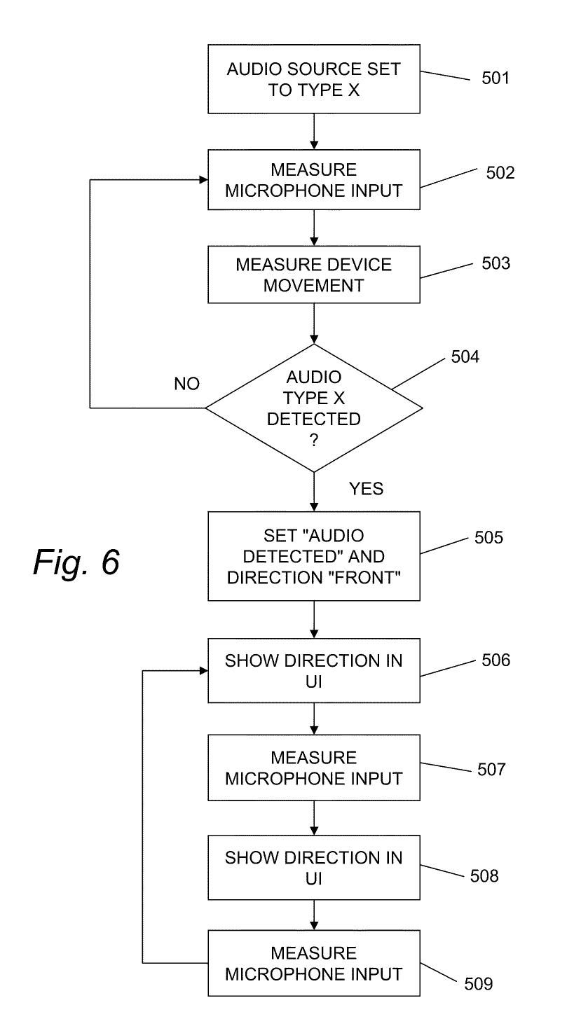

Operation of the MT 101 in accordance with an alternative example of the invention will now be described with reference to FIG. 6. Initially, the user sets the type of audio they want to detect (block 501). This may be from a list of profiles stored in the MT 101 as described above. The sound mapping program then 101 starts monitoring the microphone (block 502) and measuring device movement (block 503) at the same time. The sound mapping program 201 uses the sound detection algorithm to detect audio ‘x’, as selected at block 501. Movement is detected using the motion sensor 113 and the sound direction detection algorithm, in manner similar to that described above.

If the selected sound is not detected, bocks 502 and 503 are repeated (block 504). If the selected sound is detected, the sound mapping program 201 informs the user by displaying “audio detected” and direction “front” on the display (block 505). The sound mapping program then displays the direction from which the sound is originating on the display 107 (block 506).

In this example, the sound mapping program 201 is arranged to continuously monitor the microphone 105 and motion sensor 113 in order to update the information being fed back to the user. This is shown in blocks 507 and 508. The sound mapping program then determines whether there has been any change in a) the presence of audio x; and b) the direction of audio x (block 509). This is then fed back to the user at block 506. This process continues until the user stops the program. If audio x stops, the user is informed and given the option to continue listening, or to terminate the current detection process.

In an alternative example, the MT 101 includes a digital compass. As a user rotates the MT 101, the sound direction detection algorithm is able to plot sound levels against points on the compass. The sound detection algorithm 202 is then able to calculate the direction of the sound, relative to the compass points, based on any maximum in the levels. This information can then be passed to the sound mapping program 201.

In a further example, the MT 101 includes three directional microphones, each pointing at an angle 120° from the other microphones in the plane of the MT 101. The sound direction detection algorithm 202 can then use triangulation techniques to determine the direction from which the sound is originating. This removes the need for the user to rotate the MT 101 in order to detect sound direction.

In a further example of the invention, the sound mapping program 201 can navigate a user to the source of a particular sound. This may be achieved by displaying an arrow, in the style of a compass, which points in the direction of a sound selected by a user. The sound mapping program continuously monitors the microphone 105 and the motion sensor 113 in order for the algorithms to update the sound mapping program 201 with information on the selected sound. In this manner, the sound mapping program 201 can help a deaf person navigate to a particular sound.

In a further example of the invention, the MT 101 includes a GPS unit for determining the location of the MT 101. In this example, when the sound mapping program 201 estimates the type and direction of a particular sound, it uses the GPS unit to associate a particular position with the detected sound type. For example, the sound mapping program 201 may assume that any detected sound is 50 metres away in the direction of detection. When a sound is detected, the sound mapping program 201 can estimate the coordinates of the sound source. For example, if a sound is detected south of the current location, the sound source can be estimated to be 50 metres south of the current location. The calculated coordinates are then associated with the sound.

In this manner, if the sound stops, the sound mapping program 201 has estimated coordinates for that sound. The MT 101 can therefore direct a user to that sound, even if the sound stops. Other location determination technologies may be used in place of a GPS unit to determine current location. For example, cellular triangulation may be used

In a further example of the invention, the sound mapping program 201 may use triangulation techniques to determine a more accurate estimate of the location of a sound. Initially, an estimate of the location of a sound is carried out as described above. This is stored together with a profile of the detected sound. The user then moves a certain distance and the sound mapping program tries to detect the sound using the stored sound profile. If the sound is detected, the direction is determined. Using the previous MT location, and the new MT location, and the sound direction at each location, the sound location can be determined. Using these techniques, MT 101 can provide the user with more accurate information concerning the location of a sound. This may be fed back to the user using the display 107.

An example of the invention is an apparatus as defined in the claims. This apparatus may be a component provided as part of a chip on an electronic circuit board. Alternatively the apparatus may be a chip on an electronic circuit board. As a further alternative, the apparatus may be a computing device, such as a mobile phone. The features defined in the claims may be implemented in hardware. Alternatively, the features may be implemented using software instructions which may be stored in a memory provided on the component, chip or computing device.

Various modifications, changes, and/or alterations may be made to the above described examples to provide further examples which use the underlying inventive concept, falling within the spirit and/or scope of the invention. Any such further examples are intended to be encompassed by the appended claims.

1. An apparatus comprising: at least one processor and at least one memory including computer program code, the at least one memory and the computer program code configured to, with the at least one processor, cause the apparatus at least to:
identify at least one audio type based on a signal representative of sound;
determine the direction of any of said identified audio types; and
provide feed-back to a user of the identified audio types and the direction of said audio types.

2. An apparatus according to claim 1, further comprising at least one audio input, wherein said signal representative of sound is received via said at least one audio input.

3. An apparatus according to claim 2, wherein said at least one audio input port is at least one microphone.

4. An apparatus according to claim 1, further comprising a display, and said feed-back is displayed on said display.

5. An apparatus according to claim 1, further comprising a motion sensor, and said processor uses an output from said motion sensor to determine the direction of the at least one audio type.

6. An apparatus according to claim 1, further comprising a digital compass, and said processor uses an output from said digital compass to determine the direction of the at least one audio type.

7. An apparatus according to claim 1, having a plurality of audio profiles stored thereon, and said processor identifies audio types based on said audio profiles.

8. An apparatus according to claim 1, wherein said audio input port is suitable for a microphone to be coupled to.

9. A personal mobile communication device comprising the apparatus of claim 1

10. A method comprising:
identifying at least one audio type based on a signal representative of sound received via at least one audio input;
determining the direction of any of said identified audio types; and
providing feed-back to a user of the identified audio types and the direction of said audio types.

11. A method according to claim 10, wherein providing feed-back includes providing feed-back via a display.

12. A method according to claim 10, wherein determining direction is done using a motion sensor.

13. A method according to claim 10, wherein determining direction is done using a digital compass.

14. A method according to claim 10, wherein identifying at least one audio type is done using a plurality of audio profiles.

15. A method according to claim 10, further comprising navigating a user to an audio type selected by a user.

16. A method according to claim 10, wherein identifying at least one audio type includes identifying a single audio type selected by a user.

17. A method according to claim 10, wherein identifying at least one audio type includes identifying all audio types present in said signal representative of sound.

18. A computer program or suite of computer programs arranged such that when executed by a computer they cause the computer to operate in accordance with the method of claims 10 to 17.

19. A computer readable medium storing the computer program, or at least one of the suites of computer programs, according to claim 15.

20. An operating system for causing a computing device to operate in accordance with a method as claimed in claims 10 to 17.
